(19) United States
(12) Patent Application Publication
(10) Pub. No.: US 2004/0007519 A1
(43) Pub. Date: Jan. 15, 2004

(54) Filtering apparatus and method of manufacturing rolled filter element to be used therefor

(75) Inventor: Hirohide Sasaki, Fuji-shi (JP)

Correspondence Address: OLIFF & BERRIDGE, PLC, P.O. BOX 19928, ALEXANDRIA, VA, 22320, US

(73) Assignee: NIHON ROKA KOGYO KABUSHIKIKAISYA, Fuji-shi (JP)

(21) Appl. No.: 10/194,010

(22) Filed: Jul. 15, 2002

(51) Int. Cl. B01D 27/00

(52) U.S. Cl. 210/435

(57) ABSTRACT

The present invention relates to a filtering apparatus including a filter element formed by winding thin paper into a rolled state, and a method of manufacturing a filter element roll for the filtering apparatus, and is intended to provide a highly accurate filtering capability irrespective of a single-tier construction.

The thin paper unwound from the wide rolled paper material is separated by a slitter, and a corrugation forming roller having a circumferential groove formed for each paper strip of thin paper is disposed downstream of the slitter, so that corrugations is continuously formed at one end of the divided paper strip with respect to the centerline by the circumferential groove. By winding the thin paper having corrugation, a filter element roll having a higher density at one end than the other end is obtained.

### BACKGROUND OF THE INVENTION

1. Field of the Invention

The present invention relates to a filtering apparatus using a filter element manufactured by winding a thin paper into a rolled state and a method of manufacturing a rolled filter element to be used therefor, and is suitable for removing foreign substances in lubricating oil systems such as a bearing.

2. Description of the Related Art

A type of filtering apparatus is well known in which the filtering apparatus is manufactured by the steps of winding a wide piece of thin paper from a rolled paper material, cutting the thin paper into a plurality of narrow pieces by means of a slitter, winding each narrow piece in a rolled state to produce a filter element, press fitting the filter element into a case having a large opening at one end and a center hole at the other end, and further press fitting the case into a housing. The filtering apparatus is used by introducing a fluid to be filtered {such as lubricating oils} into the housing whereby the fluid is flown from the inlet end of the filter element to the other end thereof so that foreign substances in the fluid is colleted.

In the filtering apparatus of this type, since foreign substances in fluid are captured by paper fibers together constituting the rolled filter element, it is required to increase the filter density of the filter element in order to improve the capturing accuracy to the level in which small foreign substances can surely be captured. However, if the filter density of the filter element is increased, foreign substances of relatively large sizes are likely to be caught at a portion of the surface layer side (entry side) of the filter element and the portion is highly likely to be clogged whereby the flow rate of the filter element may be lowered although the under layer side (exit side) thereof still has enough capturing capability left and consequently, the life of the filer element comes to the end. Accordingly, the filter density of the filter element is generally set relatively large in order to avoid such consequences or in order to ensure a certain prolonged period of life. Further, if a high accuracy is required, a tandem multi-tier construction is employed in which a coarse filter element having a low filter density is disposed on the upper tier, and a fine filter element having a high filter density is disposed on the lower tier. However, such a construction results in increase in costs.

### SUMMARY OF THE INVENTION

Accordingly, it is an object of the present invention to provide a single filter element roll (single-tier construction) with highly accurate filtering capability.

The first aspect of the invention provides a filtering apparatus for capturing foreign substances comprising a rolled filter element produced by winding a thin paper, and a cylindrical case for accommodating the rolled filter element, the case having two openings at both ends thereof with respect to the axis direction of the rolled filter element accommodated, one of which is an entry opening though which a fluid to be filtered is flown into the cylindrical case and the other of which is an exit opening through which the fluid already filtered is flown out therefrom, and the filter density of the rolled filter element being higher on the exit opening side than on the entry opening side.

According to the first aspect of the invention, since a fluid to be filtered is introduced into the cylindrical case whereby the fluid is flown from one end to the other end in the axis direction of the rolled filter element. The filter density of the filter element is higher on the exit opening side than on the entry opening side. Accordingly, coarse particles are captured at the lower filter density portion on the entry opening side and fine particles are captured at the higher filter density portion on the exit opening side. Therefore, particles of various sizes are captured at the corresponding portions of a single, rolled filter element, whereby manufacturing costs may be reduced. In addition, since the life of the rolled filter element is prolonged, reductions in running costs can be accomplished.

The second aspect of the invention provides a filtering apparatus for capturing foreign substances comprising a rolled filter element produced by winding a thin paper, and a cylindrical case for accommodating the rolled filter element, the case having two openings at both ends thereof with respect to the axis direction of the rolled filter element, one of which is an entry opening though which a fluid to be filtered is flown into the cylindrical Case and the other of which is an exit opening through which the fluid is flown out therefrom, and each rolled thin paper layer, which together make the rolled filter element, having a circumferentially extending corrugated area on the exit opening side.

According to the second aspect of the invention, a fluid to be filtered is introduced into the cylindrical case whereby the fluid is flown from one end to the other end in the axis direction of the rolled filter element. Each thin paper layer has a circumferentially extending corrugated area on the exit opening side, whereby the rolled filter element has a portion in which the corrugated areas are overlapped. The portion has a higher filter density than the other portion. Thus, the same operation and effects as in the first aspect of the invention are accomplished. In addition, provision of different filter densities on the single, rolled filter element may be realized simply by providing a corrugated area on a thin paper, which contributes to reductions in costs.

The third aspect of the invention provides a filtering apparatus for capturing foreign substances comprising a plurality rolled filter elements each produced by winding a thin paper, a plurality of cylindrical cases each for accommodating the rolled filter element, the case having two openings at both ends thereof with respect to the axis direction of the rolled filter element accommodated, one of which is an entry opening though which a fluid to be filtered is flown into the cylindrical case and the other of which is an exit opening through which the fluid already filtered is flown out therefrom, and the filter density of the rolled filter element being higher on the exit opening side than on the entry opening side, and a housing for accommodating the cylindrical cases in a multi-tier construction and allowing a fluid to be filtered to be flown therein in a parallel manner.

According to the third aspect of the invention, since each thin paper layer has a circumferentially extending corrugated area, and the corrugated area makes a higher filter density portion at the exit opening area in the rolled filter element than the other portion, the same operation and effects as in the first aspect of the invention are accomplished. That is, particles of various sizes can be captured by the single, rolled filer element. In addition, a large volume of flow can be treated by disposing a plurality of such rolled filter elements in the housing so as to allow a fluid to be filtered to be flown in a parallel manner to enter into the rolled filter elements.

The fourth aspect of the invention provides a method of manufacturing a rolled filter element to be used for the filtering apparatus comprising the step of: winding a thin paper unwound from a rolled paper material, dividing the thin paper into separate pieces, forming a portion of each piece with a continuous corrugation area, and winding each piece with the continuous corrugation area to make a rolled filer element, each continuous corrugation area being positioned aside from the center to the one side with respect to the axis direction of the rolled filter element.

According to the fourth aspect of the invention, a continuous corrugation area is formed on the thin paper prior to winding. Thus, the resultant rolled filter element has a higher filter density portion at one end in the axis direction thereof than the other end. This characteristic rolled filter element can be manufactured easily and surely.

The fifth aspect of the invention provides a method of manufacturing a rolled filter element comprising the steps of winding a thin paper unwound from a wide rolled paper material, dividing the thin paper into separate pieces by means of a slitter, forming a portion of each piece with a continuous corrugation area by means of a corrugation forming roller, the corrugation forming roller having a plurality of circumferential grooves, respectively for corresponding to the pieces and being positioned downstream of the slitter with respect to the flow of the pieces, and winding each pieces with the continuous corrugation area to make a rolled filter element, each continuous corrugation area being positioned aside from the center to the one side with respect to the axis direction of the rolled filter element.

According to the fifth aspect of the invention, since one corrugation forming roller having circumferential grooves is disposed respectively for corresponding to the pieces of the thin paper downstream of the slitter, each piece is formed with a corrugation continuously upon being passed over the circumferential groove and then is wound into a rolled state. Therefore, provision of the corrugation forming roller having circumferential grooves, respectively, for the pieces of the thin paper effectively realizes easy and reliable formation of corrugation.

### BRIEF DESCRIPTION OF THE DRAWINGS

FIG. 1 is a schematic plan view of a corrugation forming and winding system for a filter element according to the invention;

FIG. 2 is a schematic side view of the corrugation forming and winding system for the filter element according to the invention;

FIG. 3 is a plan view of a single corrugation forming roller;

FIG. 4 is a schematic drawing illustrating in a resulting rolled filter element the state or the corrugation areas;

FIG. 5 is a drawing showing the first step (insertion of a mandrel) for assembling the filtering apparatus;

FIG. 6 is a drawing showing the second step (fitting of the case) for assembling the filtering apparatus;

FIG. 7 is a cross sectional view of the cylindrical case (taken along the line VII-VII shown by the arrow in FIG. 8);

FIG. 8 is a detailed cross sectional view of the upper portion of the filtering apparatus in the assembled state; and

FIG. 9 is across sectional view of the entire construction of the filtering apparatus in the assembled state.

### DESCRIPTION OF THE PREFERRED EMBODIMENTS

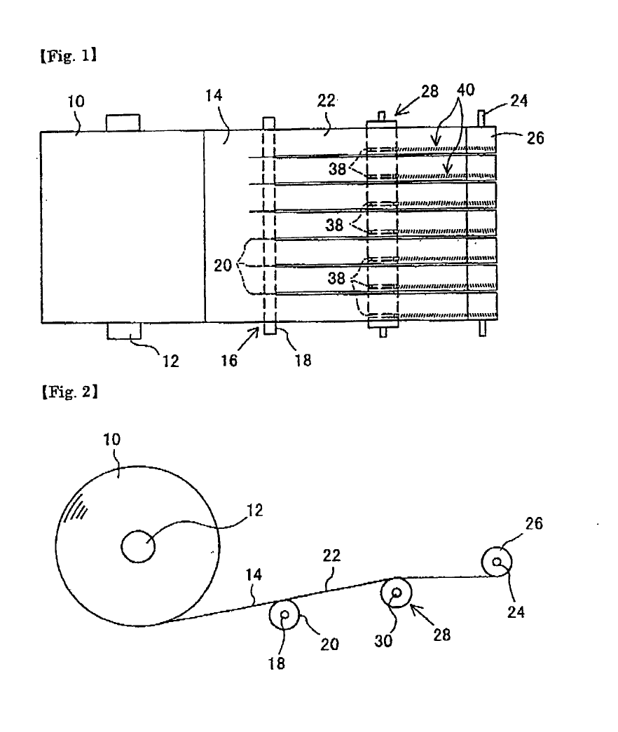

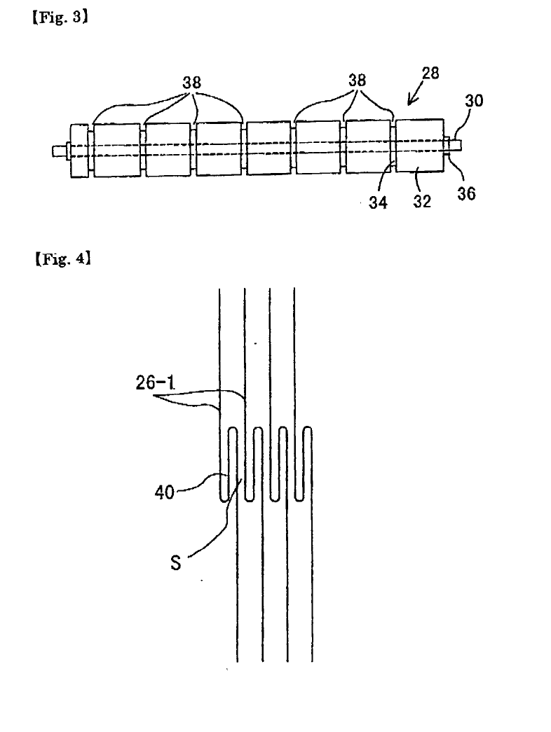

Referring now to the drawings, an embodiment of the invention will be described. FIG. 1 and FIG. 2 illustrate a corrugation forming process and a winding step from a rolled paper material 10. The rolled paper material 10 is attached to a center shaft 12, and the center shaft 12 is rotatably supported by a bearing, not shown, and connected to a rotational drive unit and the like, not shown. A slitter 16 is disposed downstream with respect to the delivering directionof an unwound paper material 14 from the rolled paper material 10. The slitter 16 comprises a revolving shaft 18 and a plurality (six in the embodiment shown in the figure) of circular blades 20 disposed farther apart from each other on the revolving shaft 18. The revolving shaft 12 is supported by a bearing, not shown, and connected to a rotational drive unit for rotation, not shown. Rotation of the center shaft 12, or in other words, rotation of the circular blades 20 divides the paper material 14 into seven elongated pieces 22, and each piece is wound on a paper pipe on a spindle 24 to make a rolled filter element 26. The spindle 24 is also supported by a bearing, not shown, and is connected to a rotational drive unit, not shown.

A corrugation forming roller 28 is disposed downstream of the slitter 16 and upstream of a winding station for making the rolled filter element 26. As shown in FIG. 3, a corrugation forming roller 28 includes a revolving shaft 30 and a plurality (eight in the embodiment shown in the figure) of large diameter roller 32 fitted onto the revolving shaft 30, small diameter rollers 34 disposed between the adjacent large diameter rollers 32, and securing members 36 disposed at both ends for maintaining the rollers 32, 34 in a fixed state. In such a construction having the small diameter rollers 34 each being interposed between the adjacent large diameter rollers 32, there is provided a plurality (seven in this embodiment) of annular grooves 38, the number of which is the same as that of the pieces 22. A shown in FIG. 1, each annular groove 38 is disposed at a position aside from the centerline to one end with respect to the width direction of each piece 22. As shown in FIG. 2, the corrugation forming roller 28 is positioned in a height so that the running routes of the pieces 22 are bent to form an slightly upwardly projecting angle. The revolving shaft 30 of the corrugation forming roller 28 is supported by a bearing, not shown, and is connected to a rotational drive unit, not shown.

After the unwound paper material 14 is slit into the pieces 22, the pieces 22 are passed over the corrugation forming roll 28. When passing over the corrugation forming roll 28, each piece is in no contact with the corrugation forming roll 28 at a position facing the annular groove 38. In addition, the corrugation forming roller 28 is positioned in a height so as to bend the running route of the pieces 22 into a slightly upwardly projecting angle. Therefore, each piece 22 is tensed and pressed against the corrugation forming roller 28, and the no contact portion of each piece 22 corresponding to each annular groove 38 is forced and guided into each annular groove 38. As a result, the no contact portion of each piece 22 is formed with a continuous corrugation area 40. The width of the continuous corrugation area 40 may suitably be adjusted by altering the width of the annular groove 38. The position of each corrugation area 40 is offset slightly from the centerline of each piece 22. The corrugation area 40 once formed is not restored and remains as is even when the piece 22 is rolled to make the rolled filter element 26. Such corrugation extends circumferentially at the position offset from the axial center of the rolled filter element 26.

FIG. 4 schematically illustrates an axial cross piece of the rolled filter element 26 at a portion where the corrugation area 40 is formed. The reference numeral 26-1 designates layers produced by winding one piece 22. Each layer has a corrugated area 40. In the corrugated area 40, the piece 22 is felled into a pile. Accordingly, the filter density of the filter element 26 is higher on this portion than on the other (no corrugation) portion. Therefore, the filer density of the filter element 26 may be varied on a single roll 26 by presence or absence of the corrugation.

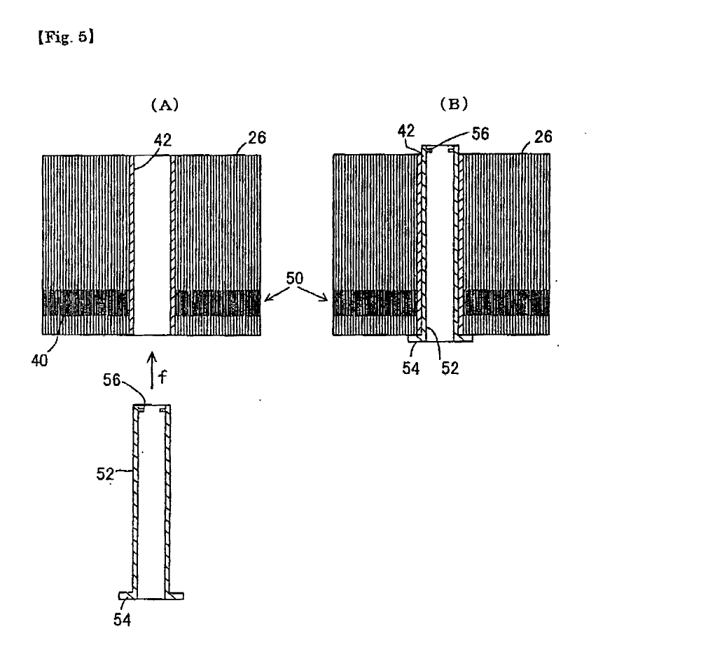

FIG. 5 to FIG. 9 illustrate the construction of a filtering apparatus including the rolled filter element 26 of the construction described above as well as the assembling procedure. FIG. 5A illustrates the first step of assembly, and the rolled filter element 26 is schematically illustrated in a cross piece taken in the axial direction. A reference numeral 42 designates a paper pipe, and vertical lines schematically illustrate layers produced by winding the piece 22. The corrugated areas 40 of the layers provide the rolled filter element 26 with a higher filter density portion. This higher filter density portion is schematically shown as a portion 50 drawn with increased number of vertical lines. The portion having a higher filter density of the rolled filter element 26 is located at a lower side of the rolled filter element 26 with respect to the center thereof. A reference numeral 52 designates a plastic mandrel. The mandrel 52 has a flange 54 extending outwardly from the outer periphery thereof at the lower end, and an annular projection 56 extending inwardly from the inner periphery thereof at an upper end. The annular projection 56 is provided for attaching an 0-ring at the inner periphery of the upper end. The mandrel 52 is inserted into the paper pipe 42 until the flange 54 abuts against the paper pipe 42 as shown by an arrow f. FIG. 5B illustrates a state in which the mandrel 52 has been inserted.

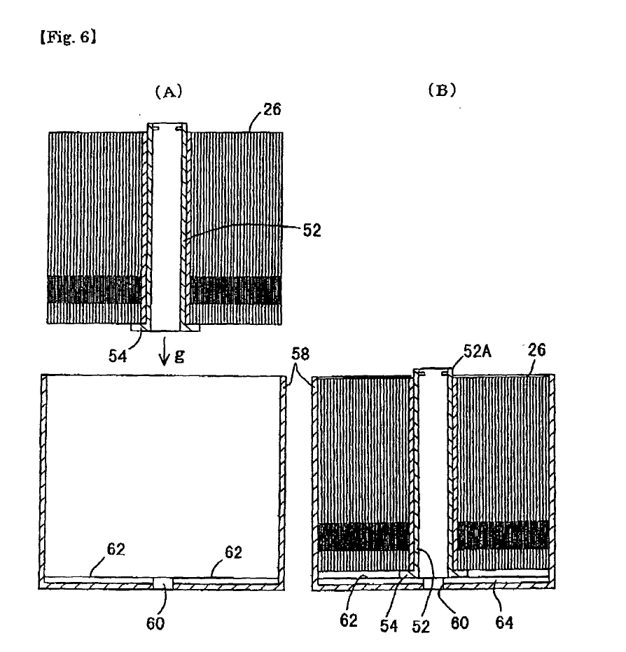

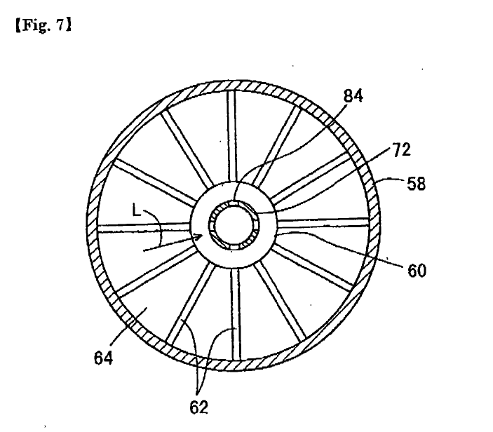

FIG. 6 illustrates the second step of assembly. The rolled filter element 26,into which the mandrel 52 has been inserted, is press fitted into a plastic case 58, as shown by an arrow g. The case 58 is fully opened at the upper side and has, at the lower side, a bottom wall with an opening 60 formed therein. As shown in FIG. 7, radially extending ribs 62 are formed on the inner surface of the bottom wall, and a space between adjacent ribs 62 form a recess 64, which extends to the opening 60. FIG. 6B illustrates a state in which fitting of the rolled filter element 26 into the plastic case 58 has been completed. In this fitted state, the flange 54 of the mandrel 52 abuts against the ribs 62 on the inner surface of the plastic case 58, and thus a flow passage of a fluid to be filtered is formed from the rolled filter element 26 through the recess 64 between the ribs 62 to the opening 60. Since the upper end of the rolled filter element 26 is the same with or slightly lower than that of the plastic case 58 and the upper end 52A of the mandrel 52 is slightly upwardly projected from the plastic case 56, a gap is formed between the adjacent plastic cases 58 when another plastic case 58 is placed thereon. Accordingly, a fluid to be filtered can surely be flown from the upper side into each rolled filter element 26.

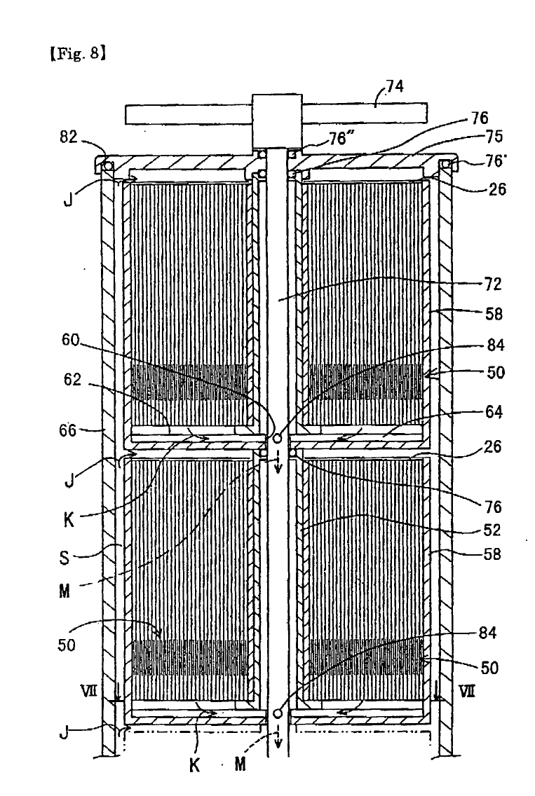

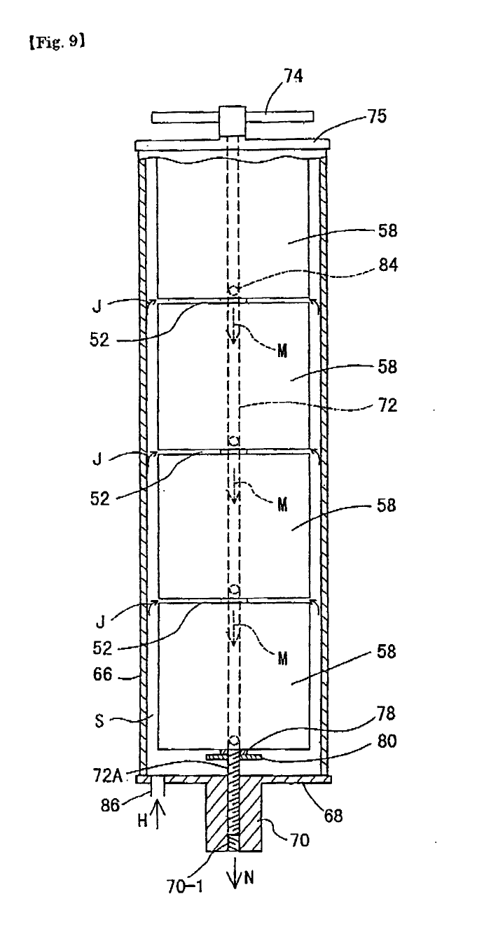

FIG. 8 and FIG. 9 illustrate the third step of assembly. In the third step, a plurality of the cases 58 each with the rolled filter element 26 are accommodated in a metallic housing 66 in a multi-tier construction (four-tier in this embodiment). The housing 66 has a cylindrical shape and integrally fixed to a bottom supporting plate 68 (FIG. 9) so as to stand uprisingly therefrom by a suitable means such as welding. The bottom supporting plate 68 has a boss portion 70 with a central hole 70-1 formed therein. The central hole 70-1 of the boss portion 70 is threaded. On the other hand, a metallic cylindrical shaft 72 is provided with a handle 74 at the upper end thereof. The cylindrical shaft 72 is inserted into a cover 75 and four-tier of the cases 58 each with the rolled filter element 26 as shown in FIG. 6B. As shown in FIG. 8, the O-ring 76 is attached on the annular projection 56 at the upper end of the mandrel 52 between the plastic cases 58 being adjacent one above the other, and the portion between the plastic cases 58 adjacent one above the other is sealed by the O-ring 76 abutted against the lower end surface of the case 58 of the upper tier, so that an unfiltered fluid (lubricating oils) is avoided to leak directly into the cylindrical shaft (exit piping side) 72. As shown in FIG. 9, the plastic case 58 of the lowest tier is placed on a metallic stopper ring 80 via a seal 78, so that the plastic cases 58 of the four-tier construction are positioned with respect to the cylindrical shaft 72. The stopper ring 80 is engaged to a threaded portion 72A at the lower end of the cylindrical shaft 72.

The cylindrical shaft 72, to which the four-tier of the plastic cases 58 each with the rolled filter element 26 is attached, is engaged to the threaded portion 72A of the threaded hole 70-1 of the boss portion 70 on the bottom supporting plate 68, as shown in FIG. 9. The cylindrical shaft 72 is engaged to the boss portion 70 by rotating a handle 74. The handle 74 is provided at the upper end. The cover 75 has, on the lower surface, an annular groove 82 along the outer peripheral side. In the annular groove 82a, a O-ring 76′ is inserted. The upper end of the housing 66 is abutted against the O-ring 76′. The cover 75 has also, on the upper surface, an annular groove. In the annular groove, another O-ring 76″ is inserted. When tightening the handle 74, the lowest case 58 of the four-tier construction is pressed against the stopper ring 80 via the seal 78. Between the adjacent plastic cases 58, the lower surface of the upper plastic case 58 is pressed against the O-ring 76 attached on the upper end of the mandrel 52 projecting from the lower plastic case 58. On the upper side of the uppermost plastic case 58, the cover 75 is pressed against the O-ring 76 attached on the upper end of the mandrel 52 projecting from the uppermost plastic case 58 in the inner periphery, and the O-ring 76′ on the outer periphery seals between the cover 75 and the housing 66. Therefore, a central cavity in the cylindrical shaft 72 acting as the exit side is completely blocked off from an internal space S acting as the entry side in the housing 66, so that no unfiltered fluid leaks directly into the exit side.

In FIG. 8, the cylindrical shaft 72 is formed with a plurality of inlet holes 84 for receiving filtered fluid farther apart from each other in the longitudinal direction. In this embodiment, these inlet holes 84 are disposed so as to face toward the openings 60 of the recesses 64 formed on the lower end of the plastic case 58 between the radially extending ribs 62 for recovering the fluid already filtered through the rolled filter element 26.

As shown in FIG. 9, the bottom plate 68 is provided with a union (connecting pipe) 86 for receiving a fluid to be filtered such as lubricating oils. A fluid to be filtered is flown from a feed pump, not shown, into the space S in the housing 66 under pressure as shown by an arrow H. The fluid, which has been flown into the housing 66, is introduced into the rolled filter element 26 in each case 58 from the upper side thereof in a parallel manner as shown by an arrows J. In this manner, the fluid introduced into rolled filter elements 26 in a parallel manner passes through the rolled filter element 26 from top to bottom, during which foreign substances are captured. The resultant, filtered fluid is flown out from the rolled filter element 26 at the lower end thereof. Then the fluid is flown within the recesses 64 between the ribs 62 radially inwardly, as shown by an arrow L (see FIG. 7), and are guided and captured via the opening 60 and the inlet hole 84 into the central cavity within the cylindrical shaft 72. The fluid thus recovered is flown downwardly through the central cavity in the cylindrical shaft 72 as shown by an arrow M, and taken out from the central hole 70-1 of the boss portion 70 on the bottom plate 68, as shown by an arrow N in FIG. 9, and then returned back to the lubricating oil system.

Foreign substances are captured by the paper fibers of the rolled filter element 26 (thin paper) when a fluid to be filtered is passed through each rolled filter element 26 from top to bottom. The upper side of the rolled filter element 26 with no corrugation is a lower filter density portion, and the lower side of the rolled filter element 26 with the corrugation area 40 is the higher filter density portion 50. Large sized foreign substances are captured at the lower filter density portion 50 and fine foreign substances are captured at the higher filter density portion 50. Therefore, one single rolled filter element 26 can capture various sizes of particles ranging from coarse particles to fine particles, and an entire area in the vertical direction of the rolled filter element 26 can be effectively used for capturing foreign substances, which contributes to increase the life of the rolled filter element. In contrast to the present invention, the prior art, rolled filter element has a uniform filter density in the vertical direction. Therefore, when the density of the filter element is increased to capture fine foreign substances, lowering of flow rate may be caused once large sized foreign substances are captured on the upper side, and thus the roll may ends its life even when the lower side thereof still has a capturing capability. Accordingly, it is required to provide a plurality of rolled filter elements having different filter densities and disposed in a tandem two-tier construction, which may be led to increase in costs. The invention forms coarse portion and fine portion on one single rolled filter element by forming corrugation during winding step, and thus the manufacturing costs and the running costs may be improved, thereby realizing significant total reduction in costs.

What is claimed is:

1. A filtering apparatus for capturing foreign substances comprising;
a rolled filter element produced by winding a thin paper, and
a cylindrical case for accommodating the rolled filter element,
the case having two openings at both ends thereof with respect to the axis direction of the rolled filter element accommodated, one of which is an entry opening though which a fluid to be filtered is flown into the cylindrical case and the other of which is an exit opening through which the fluid already filtered is flown out therefrom, and
the filter density of the rolled filter element being higher on the exit opening side than on the entry opening side.

2. A filtering apparatus for capturing foreign substances comprising;
a rolled filter element produced by winding a thin paper, and
a cylindrical case for accommodating the rolled filter element,
the case having two openings at both ends thereof with respect to the axis direction of the rolled filter element, one of which is an entry opening though which a fluid to be filtered is flown into the cylindrical case and the other of which is an exit opening through which the fluid is flown out therefrom, and
each rolled thin paper layer, which together make the rolled filter element, having a circumferentially extending corrugated area on the exit opening side.

3. A filtering apparatus for capturing foreign substances comprising;
a plurality rolled filter elements each produced by winding a thin paper,
a plurality of cylindrical cases each for accommodating the rolled filter element,
the case having two openings at both ends thereof with respect to the axis direction of the rolled filter element accommodated, one of which is an entry opening though which a fluid to be filtered is flown into the cylindrical case and the other of which is an exit opening through which the fluid already filtered is flown out therefrom, and
the filter density of the rolled filter element being higher on the exit opening side than on the entry opening side, and
a housing for accommodating the cylindrical cases in a multi-tier construction and allowing a fluid to be filtered to be flown therein in a parallel manner.

4. A method of manufacturing a rolled filter element to be used for the filtering apparatus comprising the step of:
winding a thin paper unwound from a rolled paper material,
dividing the thin paper into separate pieces,
forming a portion of each piece with a continuous corrugation area, and
winding each piece with the continuous corrugation area to make a rolled filer element,
each continuous corrugation area being positioned aside from the center to the one side with respect to the axis direction of the rolled filter element.

5. A method of manufacturing a rolled filter element comprising the steps of:
winding a thin paper unwound from a wide rolled paper material,
dividing the thin paper into separate pieces by means of a slitter,
forming a portion of each piece with a continuous corrugation area by means of a corrugation forming roller,
the corrugation forming roller having a plurality of circumferential grooves, respectively for corresponding to the pieces and being positioned downstream of the slitter with respect to the flow of the pieces, and
winding each pieces with the continuous corrugation area to make a rolled filter element,
each continuous corrugation area being positioned aside from the center to the one side with respect to the axis direction of the rolled filter element.
